(19) United States
(12) Patent Application Publication
(10) Pub. No.: US 2024/0063476 A1
(43) Pub. Date: Feb. 22, 2024

(54) Pouch and Secondary Battery Comprising the Same, and Method for Manufacturing the Same

(71) Applicant: LG Energy Solution, Ltd., Seoul (KR)

(72) Inventors: Ji Eun Lee, Daejeon (KR); Eun Ju Lee, Daejeon (KR); Hyun Min Kim, Daejeon (KR)

(73) Assignee: LG Energy Solution, Ltd., Seoul (KR)

(21) Appl. No.: 18/038,127

(22) PCT Filed: Dec. 22, 2021
(86) PCT No.: PCT/KR2021/019595

§ 371 Date: May 22, 2023

(30) Foreign Application Priority Data
Dec. 23, 2020 (KR) 10-2020-0182658

(51) Int. Cl. H01M 50/105; H01M 50/178; H01M 50/119; H01M 50/121; H01M 50/129; H01M 50/30

(52) U.S. Cl. CPC H01M 50/105; H01M 50/178; H01M 50/119; H01M 50/121; H01M 50/129; H01M 50/394

(57) ABSTRACT

A pouch and a secondary battery including the pouch, and a method for manufacturing the same are described. The method for manufacturing the secondary battery includes: a hole formation process of forming a degassing hole in an aluminum sheet; and a lamination process of laminating a polymer layer on the aluminum sheet to manufacture a pouch; an accommodation process of accommodating an electrode assembly in the pouch; and a sealing process of sealing an outer circumferential surface of the pouch.

### CROSS-REFERENCE TO RELATED APPLICATIONS

The present application is a national phase entry under 35 U.S.C. § 371 of the International Application No. PCT/KR2021/019595 filed on Dec. 22, 2021, which claims priority from Korean Patent Application No. 10-2020-0182658, filed on Dec. 23, 2020, the disclosures of which are incorporated herein by reference in their entireties.

### FIELD OF THE INVENTION

The present invention relates to a pouch and a secondary battery comprising the same, and a method for manufacturing the same.

### BACKGROUND OF THE INVENTION

Secondary batteries are rechargeable unlike primarily batteries, and also, the possibility of compact size and high capacity is high. Thus, recently, many studies on secondary batteries are being carried out. As technology development and demands for mobile devices increase, the demands for secondary batteries as energy sources are rapidly increasing.

Rechargeable batteries are classified into coin type batteries, cylindrical type batteries, prismatic type batteries, and pouch type batteries according to a shape of a battery case. In such a secondary battery, an electrode assembly mounted in a battery case is a chargeable and dischargeable power generating device having a structure in which an electrode and a separator are stacked.

The electrode assembly may be approximately classified into a jelly-roll type electrode assembly in which a separator is interposed between a positive electrode and a negative electrode, each of which is provided as the form of a sheet coated with an active material, and then, the positive electrode, the separator, and the negative electrode are wound, a stacked type electrode assembly in which a plurality of positive and negative electrodes with a separator therebetween are sequentially stacked, and a stack/folding type electrode assembly in which stacked type unit cells are wound together with a separation film having a long length.

In the secondary battery, gas is generated due to internal electrolyte decomposition under the influence of changes in temperature and potential during a driving process. In the case of normal driving conditions, although it is a small amount, it is a level that is not ignored considering that the battery guarantee period is more than 10 years. Various studies have been conducted to remove the gas generated inside the cell, and a method for attaching a device for discharging a gas to a cell surface has also been studied. However, there has been a problem in that cell performance is deteriorated due to leakage of an electrolyte at a sealing part and penetration of moisture through the sealing part during the device attachment process.

[Prior Art Document] (Patent Document) Korean Patent Publication No. 10-2014-0015647

### BRIEF SUMMARY OF THE INVENTION

One aspect of the present invention is to provide a pouch capable of discharging an internal gas, a secondary battery comprising the same, and a method for manufacturing the same.

A method for manufacturing a pouch, which accommodates an electrode assembly, according to an embodiment of the present invention comprises: a hole formation process of forming a degassing hole in an aluminum sheet; and a lamination process of laminating a polymer layer on the aluminum sheet.

In addition, a method for manufacturing a secondary battery according to an embodiment of the present invention comprises: a hole formation process of forming a degassing hole in an aluminum sheet; a lamination process of laminating a polymer layer on the aluminum sheet to manufacture a pouch; an accommodation process of accommodating an electrode assembly in the pouch; and a sealing process of sealing an outer circumferential surface of the pouch.

Furthermore, a pouch configured to accommodate an electrode assembly according to an embodiment of the present invention comprises: an aluminum sheet; and a polymer layer laminated together with the aluminum sheet, wherein a degassing hole is formed in the aluminum sheet.

A secondary battery according to an embodiment of the present invention comprises: an electrode assembly in which electrodes and separators are alternately stacked to be combined with each other; and a pouch configured to accommodate the electrode assembly, wherein the pouch comprises an aluminum sheet and a polymer layer laminated together with the aluminum sheet, and a degassing hole is formed in the aluminum sheet.

According to the present invention, the degassing hole may be formed in the aluminum sheet of the pouch, and the polymer may be laminated on the aluminum sheet so that the internal gas passes through the polymer layer through the degassing hole and then is discharged to the outside.

### BRIEF DESCRIPTION OF THE DRAWINGS

FIG. 1 is a plan view illustrating a hole formation process in a method for manufacturing a pouch and a secondary battery according to an embodiment of the present invention.

FIG. 2 is a cross-sectional view illustrating a lamination process in the method for manufacturing the pouch and the secondary battery according to an embodiment of the present invention.

FIG. 3 is a plan view illustrating a state before an electrode assembly is accommodated in the pouch in an accommodation process of the method for manufacturing the secondary battery according to an embodiment of the present invention.

FIG. 4 is a plan view illustrating a state in which the electrode assembly is accommodated in the pouch in the accommodation process of the method for manufacturing the secondary battery according to an embodiment of the present invention.

FIG. 5 is a plan view illustrating a sealing process in the method for manufacturing the secondary battery according to an embodiment of the present invention.

The objectives, specific advantages, and novel features of the present invention will become more apparent from the following detailed description taken in conjunction with the accompanying drawings. It should be noted that the reference numerals are added to the components of the drawings in the present specification with the same numerals as possible, even if they are illustrated in other drawings. Also, the present invention may be embodied in different forms and should not be construed as limited to the embodiments set forth herein. In the following description of the present invention, the detailed descriptions of related arts which may unnecessarily obscure the gist of the present invention will be omitted.

### Method for Manufacturing Pouch

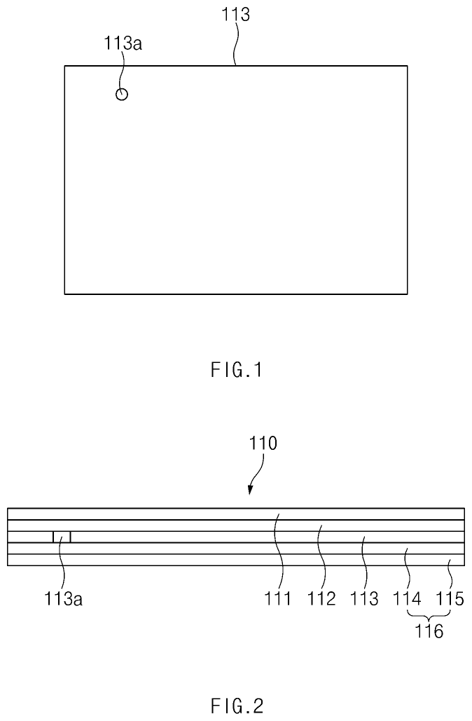

FIG. 1 is a plan view illustrating a hole formation process in a method for manufacturing a pouch and a secondary battery according to an embodiment of the present invention, and FIG. 2 is a cross-sectional view illustrating a lamination process in the method for manufacturing the pouch and the secondary battery according to an embodiment of the present invention.

Referring to FIGS. 1 and 2, the method for manufacturing the pouch according to an embodiment of the present invention is a method for manufacturing a pouch for a secondary battery, which accommodates an electrode assembly, and comprises a hole formation process of forming a degassing hole 113a in an aluminum sheet 113 and a lamination process of laminating polymer layers 111 and 116 on the aluminum sheet 113 to manufacture a pouch 110.

In more detail, referring to FIG. 1, in the hole formation process, a degassing hole 113a may be formed in the aluminum sheet 113.

In addition, in the hole formation process, the degassing hole 113a may be formed to be disposed between an electrode assembly and an outer circumferential surface of the pouch 110 when the electrode assembly is accommodated.

Also, in the hole formation process, the degassing hole 113a may be formed in a portion of the aluminum sheet 113 at a side at which an electrode lead connected to the electrode assembly is disposed.

In addition, in the hole formation process, the degassing hole 113a may be formed in the aluminum sheet 113 in a circular shape. Here, in the hole formation process, the degassing hole 113a may be formed in the aluminum sheet 113 with a size of 1 mm to 9 mm.

Referring to FIG. 2, in the lamination process, the pouch 110 may be manufactured by laminating the polymer layers 111 and 116 on the aluminum sheet 113.

The polymer layers 111 and 116 may comprise a first polymer layer 116 and a second polymer layer 111. Here, in the lamination process, the first polymer layer 116 and the second polymer layer 111 may be formed on both surfaces of the aluminum sheet 113 to cover the degassing hole 113a formed in the aluminum sheet 113. Here, each of the first polymer layer 116 and the second polymer layer 111 may comprise a polymer material. Thus, the first polymer layer 116 and the second polymer layer 111, each of which comprises the polymer material through which a gas such as CO and CO₂ is penetrated may cover the degassing hole 113a so that the internal gas is discharged, and an electrolyte is prevented from leaking the degassing hole 113a.

In the lamination process, the first polymer layer 116, the aluminum sheet 113, and the second polymer layer 111 may be stacked outward from the inside in which the electrode assembly is accommodated and then laminated.

Here, in the lamination process, the first polymer layer 116, the aluminum sheet 113, and the second polymer layer 111, each of which has a thickness of 10 μm to 90 μm, may be stacked and laminated.

In addition, in the lamination process, a nylon layer 112 may be further staked and laminated between the aluminum sheet 113 and the second polymer layer 111.

The second polymer layer 111 may be made of a polyethylene terephthalate (PET) material.

In addition, as an example, the first polymer layer 116 may be made of a polypropylene (PP) material.

In addition, as another example, an inner layer 115 in which the electrode assembly is accommodated in the first polymer layer 116 is made of a polypropylene (PP) material, and an outer layer 114 facing the aluminum sheet 113 is made of polyphthalamide (PPA) material.

### Method for Manufacturing Secondary Battery

Hereinafter, a method for manufacturing a secondary battery according to an embodiment of the present invention will be described.

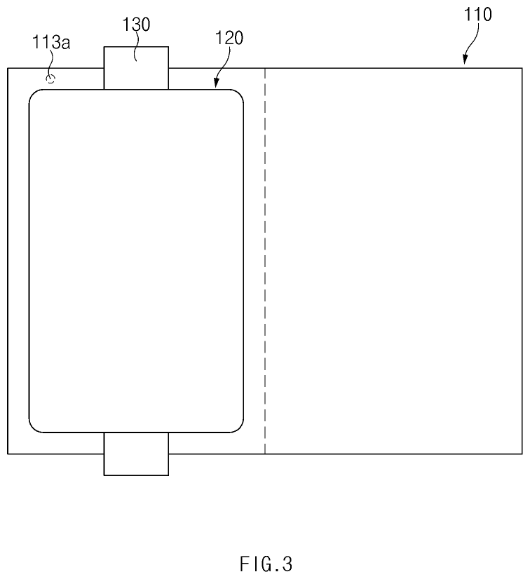

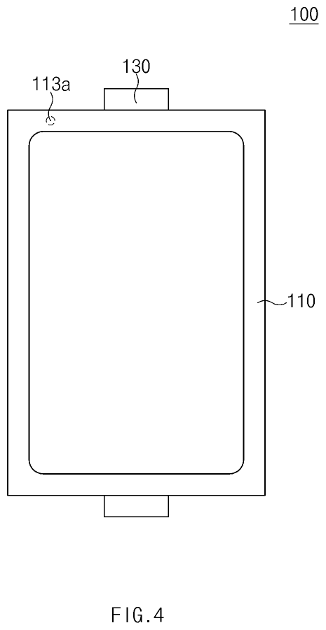

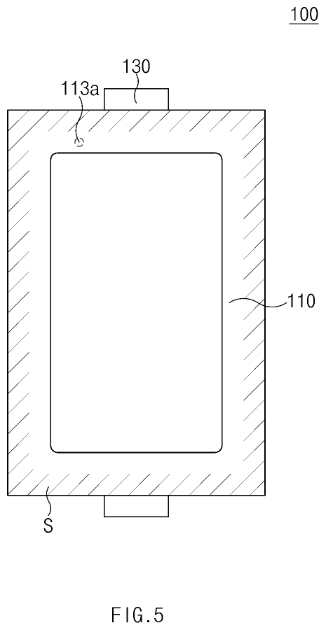

FIG. 3 is a plan view illustrating a state before an electrode assembly is accommodated in the pouch in an accommodation process of the method for manufacturing the secondary battery according to an embodiment of the present invention, FIG. 4 is a plan view illustrating a state in which the electrode assembly is accommodated in the pouch in the accommodation process of the method for manufacturing the secondary battery according to an embodiment of the present invention, and FIG. 5 is a plan view illustrating a sealing process in the method for manufacturing the secondary battery according to an embodiment of the present invention.

Referring to FIGS. 1 to 5, a method for manufacturing a secondary battery according to an embodiment of the present invention comprises a hole formation process of forming a degassing hole 113a in an aluminum sheet 113, a lamination process of laminating polymer layers 111 and 116 on the aluminum sheet 113 to manufacture a pouch 110, an accommodation process of accommodating an electrode assembly 120 in the pouch 110, and a sealing process of sealing an outer circumferential surface of the pouch 110 to manufacture a secondary battery 100.

The method for manufacturing the secondary battery according to an embodiment of the present invention relates to a method for manufacturing a secondary battery, which manufactures a secondary battery comprising a pouch manufactured through the method for manufacturing the pouch according to the foregoing embodiment. Thus, contents of this embodiment, which are duplicated with those according to the forgoing embodiment, will be omitted or briefly described, and also, differences therebetween will be mainly described.

In more detail, referring to FIG. 1, in the hole formation process, a degassing hole 113a may be formed in the aluminum sheet 113.

In addition, in the hole formation process, the degassing hole 113a may be formed to be disposed between an electrode assembly 120 and an outer circumferential surface of the pouch 110 when the electrode assembly 120 is accommodated.

Also, in the hole formation process, the degassing hole 113a may be formed in a portion of the aluminum sheet 113 at a side at which an electrode lead is disposed. That is, the degassing hole 113a may be disposed between a sealing part S formed on an outer circumferential surface of the aluminum sheet 113 in a subsequent sealing process and the electrode assembly 120 in the aluminum sheet 113, and in a plan view, the degassing hole 113a may be formed in a direction, in which the electrode lead 130 is disposed, among four directions of the secondary battery 100 (see FIGS. 3 and 5).

In addition, in the hole formation process, the degassing hole 113a may be formed in the aluminum sheet 113 in a circular shape. Here, in the hole formation process, the degassing hole 113a may be formed in the aluminum sheet 113 with a size of 1 mm to 9 mm.

Referring to FIG. 2, in the lamination process, the pouch 110 may be manufactured by laminating the polymer layers 111 and 116 on the aluminum sheet 113.

The polymer layers 111 and 116 may comprise a first polymer layer 116 and a second polymer layer 111. Here, in the lamination process, the first polymer layer 116 and the second polymer layer 111 may be formed on both surfaces of the aluminum sheet 113 to cover the degassing hole 113a formed in the aluminum sheet 113. Here, each of the first polymer layer 116 and the second polymer layer 111 may comprise a polymer material. Thus, the first polymer layer 116 and the second polymer layer 111, each of which comprises the polymer material through which a gas such as CO and CO₂ is penetrated may cover the degassing hole 113a so that the internal gas is discharged, and an electrolyte is prevented from leaking the degassing hole 113a.

In the lamination process, the first polymer layer 116, the aluminum sheet 113, and the second polymer layer 111 may be stacked outward from the inside in which the electrode assembly 120 is accommodated and then laminated.

Here, in the lamination process, the first polymer layer 116, the aluminum sheet 113, and the second polymer layer 111, each of which has a thickness of 10 μm to 90 μm, may be stacked and laminated.

In addition, in the lamination process, a nylon layer 112 may be further staked and laminated between the aluminum sheet 113 and the second polymer layer 111.

The second polymer layer 111 may be made of a polyethylene terephthalate (PET) material.

In addition, as an example, the first polymer layer 116 may be made of a polypropylene (PP) material.

In addition, as another example, an inner layer 115 in which the electrode assembly 120 is accommodated in the first polymer layer 116 is made of a polypropylene (PP) material, and an outer layer 114 facing the aluminum sheet 113 is made of polyphthalamide (PPA) material.

Referring to FIGS. 3 and 4, in the accommodation process, the electrode assembly 120 may be accommodated in the pouch 110. The electrode assembly 120 may be a chargeable and dischargeable power generation element and have a shape in which an electrode and a separator are alternately stacked to be assembled with each other.

Furthermore, in the accommodation process, for example, the electrode assembly 120 may be seated on one side of the pouch 110 and then covered with the other side to accommodate the electrode assembly 120. As another example of the accommodation process, the electrode assembly 120 may be accommodated by forming an accommodation part in which the electrode assembly 120 is accommodated.

In addition, in the accommodation process, an electrode lead 130 connecting the electrode assembly 120 to an external device may be further accommodated. Here, one side of the electrode lead 130 may be connected to an electrode of the electrode assembly 120 and accommodated in the pouch 110, and the other side of the electrode lead 130 may extend to the outside of the pouch 110 and then be connected to an external device.

Referring to FIG. 5, in the sealing process, the outer circumferential surface of the pouch 110 may be sealed.

In addition, in the sealing process, the sealing part S may be formed by sealing the outer circumferential surface of the pouch 110 in three or four directions.

In addition, in the sealing process, heat may be applied to both surfaces of the outer circumferential surface of the pouch 110 to fuse the outer circumferential surface, thereby forming the sealing part S.

### Pouch

Hereinafter, the pouch according to an embodiment of the present invention will be described.

Referring to FIGS. 1 and 2, a pouch 110 according to an embodiment of the present invention is a pouch 110 accommodating an electrode assembly 120. The pouch 110 comprises an aluminum sheet 113 and polymer layers 111 and 116, which are laminated together with the aluminum sheet 113. A degassing hole 113a is formed in the aluminum sheet 113 (see FIG. 3).

The pouch 110 according to an embodiment of the present invention relates to the pouch 110 manufactured by the method for manufacturing the pouch according to the above-described embodiment. Thus, contents of this embodiment, which are duplicated with those according to the forgoing embodiment, will be omitted or briefly described, and also, differences therebetween will be mainly described.

In more detail, the pouch 110 may accommodate the electrode assembly 120. Here, an accommodation part in which the electrode assembly 120 is accommodated may be formed in the pouch 110.

At this time, the electrode assembly 120 accommodated in the pouch 110 is a chargeable and dischargeable power generating element, and electrodes and separators are alternately stacked to be combined with each other. The electrode assembly 120 may further comprise an electrode lead 130 connected to an end of the electrode. Here, the electrode assembly 120 may be electrically connected to an external device through the electrode lead 130 (see FIG. 3).

In addition, the pouch 110 may comprise an aluminum sheet 113 and polymer layers 111 and 116 laminated together with the aluminum sheet 113.

The aluminum sheet 113 may be formed in the form of a sheet made of an aluminum material to form a layer.

In addition, a degassing hole 113a may be formed in the aluminum sheet 113. In this case, the degassing hole 113a may be formed in the aluminum sheet 113 with a size of 1 mm to 9 mm.

Also, referring to FIGS. 1 to 3, the degassing hole 113a may be formed in the pouch 110 between the electrode assembly 120 and the outer circumferential surface of the pouch 110.

Furthermore, the degassing hole 113a may be formed in a portion of the aluminum sheet 113 at a side at which the electrode lead 130 is disposed.

The polymer layers 111 and 116 may comprise a first polymer layer 116 and a second polymer layer 111. Here, the first polymer layer 116 and the second polymer layer 111 may be formed on both surfaces of the aluminum sheet 113 to cover the degassing hole 113a formed in the aluminum sheet 113. Here, each of the first polymer layer 116 and the second polymer layer 111 may comprise a polymer material. Thus, the first polymer layer 116 and the second polymer layer 111, each of which comprises the polymer material through which a gas such as CO and CO₂ is penetrated may cover the degassing hole 113a so that the internal gas is discharged, and an electrolyte is prevented from leaking the degassing hole 113a.

The first polymer layer 116, the aluminum sheet 113, and the second polymer layer 111 may be stacked outward from the inside in which the electrode assembly 120 is accommodated. Here, the first polymer layer 116, the aluminum sheet 113, and the second polymer layer 111, each of which has a thickness of 10 μm to 90 μm, may be stacked to be bonded to each other. Also, in the pouch 110, a nylon layer 112 may be further laminated between the aluminum sheet 113 and the second polymer layer 111.

The second polymer layer 111 may be made of a polyethylene terephthalate (PET) material.

In addition, as an example, the first polymer layer 116 may be made of a polypropylene (PP) material.

In addition, as another example, an inner layer 115 in which the electrode assembly 120 is accommodated in the first polymer layer 116 is made of a polypropylene (PP) material, and an outer layer 114 facing the aluminum sheet 113 is made of polyphthalamide (PPA) material.

A sealing part S may be formed on the outer circumferential surface of the pouch 110 to seal the inside of the pouch 110. In this case, the sealing part S may be formed by thermally fusing the outer circumferential surface of the pouch 110 in three or four directions.

### Secondary Battery

Hereinafter, a secondary battery according to an embodiment of the present invention will be described.

Referring to FIGS. 1 and 5, a secondary battery 100 according to an embodiment of the present invention comprises an electrode assembly, in which electrodes and separators are alternately stacked to be combined with each other, and a pouch 110 accommodating the electrode assembly 120. The pouch 110 comprises an aluminum sheet 113 and polymer layers 111 and 116, which are laminated together with the aluminum sheet 113. A degassing hole 113a is formed in the aluminum sheet 113.

The secondary battery 100 according to an embodiment of the present invention relates to the secondary battery manufactured through the method for manufacturing the secondary battery according to the foregoing embodiment. Thus, contents of this embodiment, which are duplicated with those according to the forgoing embodiment, will be omitted or briefly described, and also, differences therebetween will be mainly described.

In more detail, in the secondary battery 100 according to an embodiment of the present invention, the electrode assembly 120 may be a power generating device that is chargeable and dischargeable and be assembled by alternately stacking electrodes and separators.

Here, the electrodes may comprise a positive electrode and a negative electrode. Thus, the positive electrode, the separator, and the negative electrode may be alternately disposed.

Also, the electrode assembly 120 may further comprise an electrode lead 130 connected to an end of the electrode. Here, the electrode assembly 120 may be electrically connected to an external device through the electrode lead 130.

The pouch 110 may accommodate the electrode assembly 120. Here, an accommodation part in which the electrode assembly 120 is accommodated may be formed in the pouch 110.

In addition, the pouch 110 may comprise an aluminum sheet 113 and polymer layers 111 and 116 laminated together with the aluminum sheet 113.

The aluminum sheet 113 may be formed in the form of a sheet made of an aluminum material to form a layer.

In addition, a degassing hole 113a may be formed in the aluminum sheet 113. In this case, the degassing hole 113a may be formed in the aluminum sheet 113 with a size of 1 mm to 9 mm.

Also, the degassing hole 113a may be formed in the pouch 110 between the electrode assembly 120 and the outer circumferential surface of the pouch 110.

Furthermore, the degassing hole 113a may be formed in a portion of the aluminum sheet 113 at a side at which the electrode lead 130 is disposed.

The polymer layers 111 and 116 may comprise a first polymer layer 116 and a second polymer layer 111. Here, the first polymer layer 116 and the second polymer layer 111 may be formed on both surfaces of the aluminum sheet 113 to cover the degassing hole 113a formed in the aluminum sheet 113. Here, each of the first polymer layer 116 and the second polymer layer 111 may comprise a polymer material. Thus, the first polymer layer 116 and the second polymer layer 111, each of which comprises the polymer material through which a gas such as CO and CO₂ is penetrated may cover the degassing hole 113a so that the internal gas is discharged, and an electrolyte is prevented from leaking the degassing hole 113a.

The first polymer layer 116, the aluminum sheet 113, and the second polymer layer 111 may be stacked outward from the inside in which the electrode assembly 120 is accommodated. Here, the first polymer layer 116, the aluminum sheet 113, and the second polymer layer 111, each of which has a thickness of 10 μm to 90 μm, may be stacked to be bonded to each other. Also, in the pouch 110, a nylon layer 112 may be further laminated between the aluminum sheet 113 and the second polymer layer 111.

The second polymer layer 111 may be made of a polyethylene terephthalate (PET) material.

In addition, as an example, the first polymer layer 116 may be made of a polypropylene (PP) material.

In addition, as another example, in the first polymer layer 116, an inner layer 115 in which the electrode assembly 120 is accommodated is made of a polypropylene (PP) material, and an outer layer 114 facing the aluminum sheet 113 is made of a polyphthalamide (PPA) material.

A sealing part S may be formed on the outer circumferential surface of the pouch 110 to seal the inside of the pouch 110. In this case, the sealing part S may be formed by thermally fusing the outer circumferential surface of the pouch 110 in three or four directions.

While the present invention has been particularly shown and described with reference to exemplary embodiments thereof, it is to be understood that the scope of the present invention is not limited thereto. It will be understood by those of ordinary skill in the art that various changes in form and details may be made therein without departing from the spirit and scope of the present invention.

Furthermore, the scope of protection of the present invention will be clarified by the appended claims.

### DESCRIPTION OF THE SYMBOLS

100: Secondary battery
110: Pouch
111: Second polymer layer
112: Nylon layer
113: Aluminum sheet (113)
113a: Degassing hole
116: First polymer layer
120: Electrode assembly
130: Electrode lead
S: Sealing part

1. A method for manufacturing a pouch, which accommodates an electrode assembly, the method comprising:
forming a degassing hole in an aluminum sheet; and
laminating a polymer layer on the aluminum sheet.

2. The method of claim 1, wherein the polymer layer comprises a first polymer layer and a second polymer layer, and
wherein the first polymer layer, the aluminum sheet, and the second polymer layer are stacked outward from an inside, in which the electrode assembly is accommodated, and then laminated.

3. A method for manufacturing a secondary battery, the method comprising:
forming a degassing hole in an aluminum sheet;
laminating a polymer layer on the aluminum sheet to manufacture a pouch;
accommodating an electrode assembly in the pouch; and
sealing an outer circumferential surface of the pouch.

4. The method of claim 3, wherein the polymer layer comprises a first polymer layer and a second polymer layer, and
wherein the first polymer layer, the aluminum sheet, and the second polymer layer are stacked outward from an inside, in which the electrode assembly is accommodated, and then laminated.

5. The method of claim 4, wherein the first polymer layer is made of a polypropylene (PP) material, and
the second polymer layer is made of a polyethylene terephthalate (PET) material.

6. The method of claim 4, wherein, in the first polymer layer, an inner layer in which the electrode assembly is accommodated is made of a polypropylene (PP) material, and an outer layer facing the aluminum sheet is made of a polyphthalamide (PPA) material, and
wherein the second polymer layer is made of a polyethylene terephthalate (PET) material.

7. The method of claim 4, wherein, in the laminating, a nylon layer is further stacked between the aluminum sheet and the second polymer layer and then laminated.

8. The method of claim 3, wherein, when electrode assembly is accommodated, the degassing hole is disposed between the electrode assembly and the outer circumferential surface of the pouch.

9. The method of claim 8, further comprising accommodating an electrode lead configured to connect the electrode assembly to an external device, and
wherein the degassing hole is formed in a portion of the aluminum sheet at a side at which the electrode lead is disposed.

10. A pouch configured to accommodate an electrode assembly, the pouch comprising:
an aluminum sheet; and
a polymer layer laminated together with the aluminum sheet,
wherein a degassing hole is formed in the aluminum sheet.

11. The pouch of claim 10, wherein the polymer layer comprises a first polymer layer and a second polymer layer, and
in the pouch, the first polymer layer, the aluminum sheet, and the second polymer layer are stacked outward from an inside in which the electrode assembly is accommodated.

12. A secondary battery comprising:
an electrode assembly wherein electrodes and separators are alternately stacked to be combined with each other; and
a pouch configured to accommodate the electrode assembly,
wherein the pouch comprises an aluminum sheet and a polymer layer laminated together with the aluminum sheet, and
wherein a degassing hole is formed in the aluminum sheet.

13. The secondary battery of claim 12, wherein the polymer layer comprises a first polymer layer and a second polymer layer, and
in the pouch, the first polymer layer, the aluminum sheet, and the second polymer layer are stacked outward from an inside, in which the electrode assembly is accommodated.

14. The secondary battery of claim 13, wherein the first polymer layer is made of a polypropylene (PP) material, and
the second polymer layer is made of a polyethylene terephthalate (PET) material.

15. The secondary battery of claim 13, wherein, in the first polymer layer, an inner layer in which the electrode assembly is accommodated, is made of a polypropylene (PP) material, and an outer layer facing the aluminum sheet is made of a polyphthalamide (PPA) material, and
the second polymer layer is made of a polyethylene terephthalate (PET) material.

16. The secondary battery of claim 13, wherein, in the pouch, a nylon layer is further stacked between the aluminum sheet and the second polymer layer.

17. The secondary battery of claim 12, wherein the degassing hole is formed between the electrode assembly and an outer circumferential surface of the pouch in the pouch.

18. The secondary battery of claim 17, further comprising an electrode lead configured to connect the electrode assembly to an external device,
wherein the degassing hole is formed in a portion of the aluminum sheet at a side at which the electrode lead is disposed.
